(19) United States
(12) Patent Application Publication
(10) Pub. No.: US 2011/0233439 A1
(43) Pub. Date: Sep. 29, 2011

(54) Control head

(75) Inventor: George LEE, Taipei (TW)

(73) Assignee: Pacific Hospital Supply Co., Ltd

(21) Appl. No.: 12/732,354

(22) Filed: Mar. 26, 2010

(51) Int. Cl. F16K 1/00

(52) U.S. Cl. 251/319

(57) ABSTRACT

A control head includes a valve seat, a shaft module, an elastic member and a cap. The valve seat includes a shaft tube, and interconnected intake tube and discharge tube extended separately from the shaft tube. The shaft module having an end passed inside the shaft tube includes a moving rod, a conical piston sheathed onto a lower end of the moving rod, and an oblique surface formed separately at internal ends of the intake and discharge tubes and corresponding to an oblique surface of the conical piston. Both ends of the elastic member contained inside the shaft tube are pressed against the valve seat and the shaft module, and a cap is covered onto the valve seat, and another end of the shaft module is passed out of the cap and coupled to a press button, such that the control head can provide smooth downward pressing and resuming movements.

### BACKGROUND OF THE INVENTION

1. Field of the Invention

The present invention relates to a control head, and more particularly to a gas control valve installed onto a suction device and having a structure that can be pressed or resumed to its original position smoothly.

2. Description of Related Art

With reference to FIG. 1 for a conventional gas control valve of a suction device, the conventional gas control valve comprises a valve seat 100, a shaft module 200, an elastic member 300 and a cap 400, wherein the valve seat 100 includes a shaft tube 111, and an intake tube 112 and a discharge tube 113 extended from the shaft tube 111 respectively and interconnected with each other; the shaft module 200 has an end passed inside the shaft tube 111 and includes a moving rod 201 and a circular groove 2011 formed at a middle section of the moving rod 201; the elastic member 300 is contained inside the shaft tube 111 of the valve seat 100, and both ends of the elastic member 300 are pressed against the valve seat 100 and a corresponding surface of the shaft module 200, and a cap 400 is covered and coupled to the valve seat 100 and at a position corresponding to the shaft module 200, and another end of the shaft module 200 is passed out of the cap 400 and coupled to a press button 401, so as to form the structure of the conventional gas control valve.

With reference to FIG. 2 for another conventional gas control valve of a suction device, the conventional gas control valve comprises a valve seat 10, a shaft module 20, an elastic member 30 and a cap 40, wherein the valve seat 10 includes a shaft tube 11, and an intake tube 12 and a discharge tube 13 extended from the shaft tube 11 respectively and interconnected with each other; the shaft module 20 has an end passed into the interior of the shaft tube 11 for an operational movement, and includes a moving rod 21, and a through hole 211 formed along a radial direction on the moving rod 21 and penetrating the center of the moving rod 21; the elastic member 30 is contained inside the shaft tube 11 of the valve seat 10, and both ends of the elastic member 30 are pressed against the valve seat 10 and a corresponding surface of the shaft module 20, and the valve seat 10 includes a cap 40 covered and coupled to a position corresponding to the shaft module 20, such that another end of the shaft module 20 is passed out of the cap 40 and coupled to a press button 24, so as to form the structure of the conventional gas control valve.

However, the practical applications of the aforementioned two conventional gas control valves for a suction device still have the following drawbacks. Since the external surface of a piston 22, 202 of the conventional gas control valves must be attached closely with the internal sidewall of the shaft tube 11, 111 before communications with the intake tube 12, 112 and the discharge tube 13, 113 can be blocked without leaking gas under a sealed condition. To avoid a too-large frictional force between the piston 22, 202 and the internal sidewall of the shaft tube 11, 111 and prevent the moving speed of the shaft module 20, 200 from becoming slower due to a too-large resistance, a lubricant is usually applied between the piston 22, 202 and the internal sidewall of the shaft tube 11, 111 to reduce the resistance and enhance the moving speed of the shaft module 20, 200. However, such arrangement incurs higher labor and production costs. On the other hand, the manufactured piston 22, 202 may have a slight discrepancy of its external diameter. If the external diameter of the piston 22, 202 is too large, the shaft tube 11, 111 will be too tight and unable to resume its original position easily. If the external diameter of the piston 22, 202 is too small, then the piston 22, 202 will not be attached closely to the internal sidewall of the shaft tube 11, 111, and a leak may result. Obviously, the conventional gas control valves demand immediate improvements and feasible solutions.

### SUMMARY OF THE INVENTION

In view of the drawbacks of the conventional gas control valves, the inventor of the present invention based on years of experience in the related industry to conduct extensive researches and experiments, and finally developed a control head in accordance with the present invention.

Therefore, it is a primary objective of the present invention to provide a control head installed on a gas control valve of a suction device, wherein the control head can be pressed down or resumed to its original position smoothly.

To achieve the foregoing objective, the present invention provides a control head comprising a valve seat, a shaft module, an elastic member and a cap, wherein the valve seat includes a shaft tube, and an intake tube and a discharge tube extended from the shaft tube respectively and interconnected with each other; the shaft module has an end passed inside the shaft tube for an operational movement and includes a moving rod, a conical piston sheathed onto a lower end of the moving rod, and an oblique surface formed separately at an internal end of the intake tube and the discharge tube and corresponding to an oblique surface of the conical piston; the elastic member is contained inside the shaft tube and both ends of the elastic member are pressed against the valve seat and a corresponding surface of the shaft module, and a cap is covered and coupled to the valve seat and at a position corresponding to the shaft module, and another end of the shaft module is passed out of the cap and coupled to a press button, such that when the oblique surface of the conical piston is moved at the shaft module, the oblique surface will not be attached closely to the internal sidewall of the shaft tube, such that a smooth downward pressing movement or a smooth resuming movement can be achieved.

### BRIEF DESCRIPTION OF THE DRAWINGS

The invention, as well as its many advantages, may be further understood by the following detailed description and drawings in which:

FIG. 1 is a cross-sectional view of a conventional control head;

FIG. 2 is a cross-sectional view of another conventional control head;

FIG. 3 is a cross-sectional view of a control head of the present invention;

FIG. 4 is a schematic view of an operation of a control head in accordance with the present invention;

FIG. 5 is a schematic view of a rotation of a control head in accordance with the present invention; and

FIG. 6 is another schematic view of a rotation of a control head in accordance with the present invention.

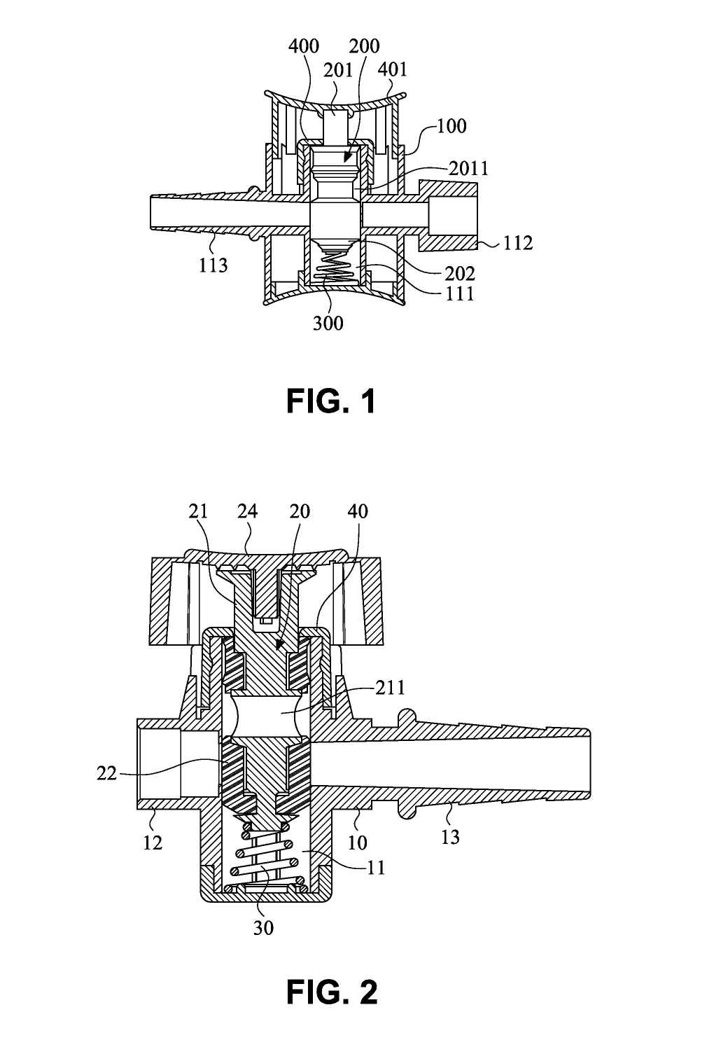

### DETAILED DESCRIPTION OF THE INVENTION

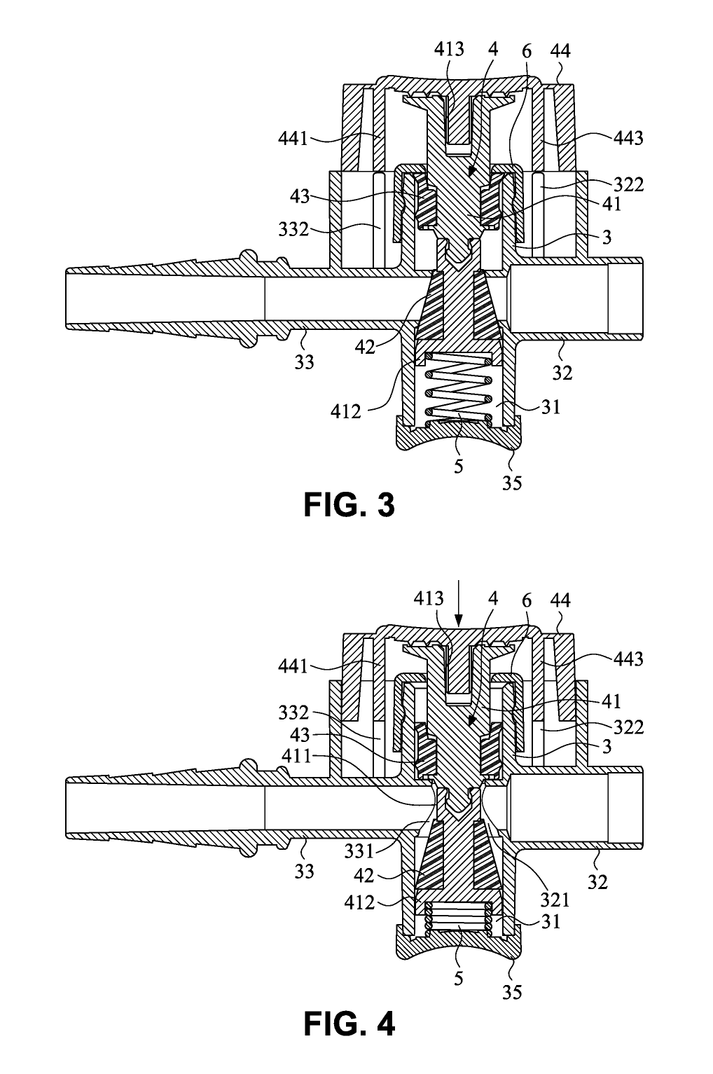

With reference to FIGS. 3 and 4 for a control head of the present invention, the control head comprises a valve seat 3, a shaft module 4, an elastic member 5 and a cap 6. The valve seat 3 comprises: a longitudinal shaft tube 31; a transverse intake tube 32 and a transverse discharge tube 33 extended from left and right sides of the shaft tube 31 respectively, wherein the shaft tube 31 is interconnected with the intake tube 32 and the discharge tube 33; and a bottom cover 35 covered and coupled to the bottom of the shaft tube 31.

An end of the shaft module 4 is passed inside the shaft tube 31 of the valve seat 3, and the shaft module 4 can perform an operational movement of the shaft tube 31. The shaft module 4 comprises a moving rod 41, a conical piston 42, an upper piston ring 43 and a press button 44, wherein the conical piston 42 is installed at a lower end of the moving rod 41, and an oblique surface 321, 331 is formed separately at internal ends of the intake tube 32 and the discharge tube 33 and corresponding to an oblique surface of the conical piston 42, and a circular groove 411 is formed at the middle section of the moving rod 41, and the upper piston ring 43 is sheathed onto an upper end of the moving rod 41. In addition, a cap body 412 is formed at a bottom end of the moving rod 41, and a concave hole 413 is formed at a top end of the moving rod 41 and coupled with the press button 44.

The elastic member 5 can be a conical spiral spring contained and installed inside the shaft tube 31 of the valve seat 3, and both ends of the elastic member 5 are pressed against internal side of the bottom cover 35 of the valve seat 3 and a side of the cap body 412 of the moving rod 41.

The cap 6 is covered and coupled to the valve seat 3 and at a position corresponding to the shaft module 4, such that a top end of the moving rod 41 of the shaft module 4 is passed out of the cap 6 and coupled to the press button 44. Further, the upper piston ring 43 is pressed against an internal edge of the top surface of the cap 6 for preventing the shaft module 4 from being pushed into the shaft tube 31 of the valve seat 3 by the elasticity of the elastic member 5.

With reference to FIGS. 3 and 4, the control head of the present invention is connected to a suction device (not shown in the figures), and the intake and discharge tubes 32, 33 of the valve seat 3 are connected to a soft tube and a negative pressure generator (not shown in the figures) respectively, such that when the control head is used, the pumping and suction effects of the negative pressure generator and the downward pressing of the shaft module 4 drives the conical piston 42 of the moving rod 41 to leave the position of the central hole that is sealed by the intake and discharge tubes 32, 33, such that the intake and discharge tubes 32, 33 can be interconnected for passing gases. Now, air flows through the surrounding of the circular groove 411 at the middle section of the moving rod 41 and out from the central hole of the discharge tube 33 of the valve seat 3 to suck and collect a patient's sputum.

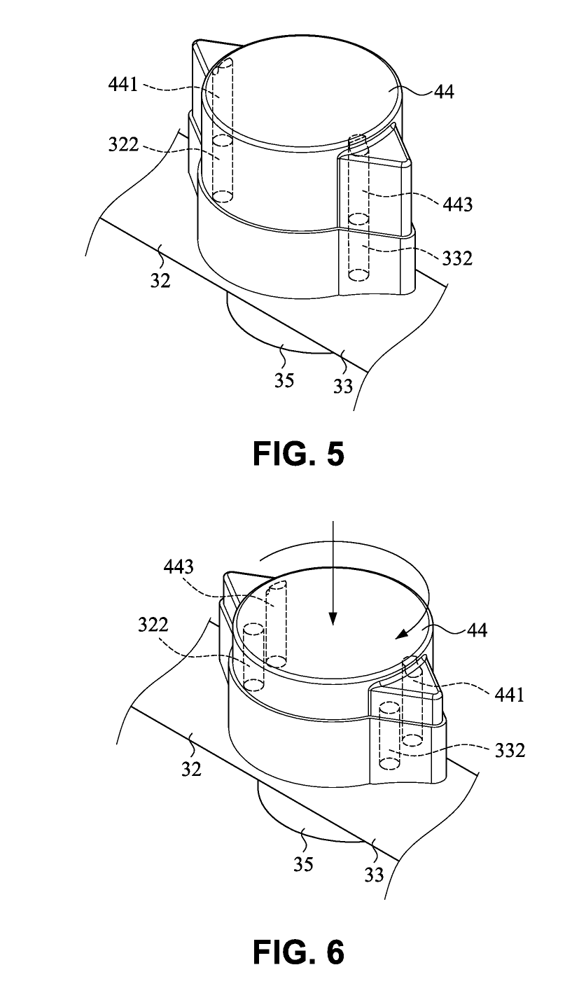

With reference to FIGS. 3, 5 and 6, a pillar 441, 443 is installed separately onto internal edges at both ends of the press button 44, and another pillar 322, 332 is installed separately on the intake and discharge tubes 32, 33 and at a position corresponding to the two pillars 441, 443 respectively, such that if it is necessary to prevent the press button 44 from being pressed by mistake, the press button 44 is turned to an angle of 90 degrees, such that the two pillars 441, 443 are disposed opposite to the two others pillar 322, 332, and when the press button 44 is pressed, the two pillars 441, 443 are pressed against the two other pillars 322, 332 respectively, and the shaft module 20 cannot be moved downward, so as to restrict the moving position and direction and prevent unnecessary suctions caused by pressing the press button 44 by mistake.

With reference to FIGS. 3 and 4 for a preferred embodiment of the present invention, the conical piston 42 is sheathed onto a lower end of the moving rod 41, or the conical piston 42 is integrally formed at the lower end of the moving rod 41.

Many changes and modifications in the above described embodiment of the invention can, of course, be carried out without departing from the scope thereof Accordingly, to promote the progress in science and the useful arts, the invention is disclosed and is intended to be limited only by the scope of the appended claims.

What is claimed is:

1. A control head, comprising:
a valve seat, including a shaft tube, and an intake tube and a discharge tube extended from both left and right sides of the shaft tube respectively, and the shaft tube being interconnected to the intake tube and the discharge tube;
a shaft module, having an end passed inside the shaft tube of the valve seat, and operationally moved with respect to the shaft tube, and the shaft module comprising a moving rod, a conical piston and a press button, and the conical piston being installed at a lower end of the moving rod, and an oblique surface being formed at internal ends of the intake tube and the discharge tube respectively and corresponding to an oblique surface of the conical piston, and a circular groove being formed at a middle section of the moving rod, and a cap body being formed at a bottom end of the moving rod, and a concave hole being formed at a top end of the moving rod and coupled to the press button;
an elastic member, contained inside the shaft tube of the valve seat, and both ends of the elastic member pressing against the valve seat and a corresponding surface of the shaft module; and
a cap, covered and coupled to the valve seat and at a position corresponding to the shaft module, such that the top end of the moving rod of the shaft module is passed out of the cap and coupled to the press button.

2. The control head of claim 1, wherein the elastic member is a conical spiral spring.

3. The control head of claim 1, wherein the press button includes a pillar installed separately at an internal edge of both ends of the press button, and another pillar installed separately at a position where the intake and discharge tubes correspond to the two pillars.

4. The control head of claim 1, wherein the shaft module further comprises an upper piston ring sheathed onto an upper end of the moving rod.

5. The control head of claim 1, wherein the conical piston is sheathed onto a lower end of the moving rod.

6. The control head of claim 1, wherein the conical piston is integrally formed at a lower end of the moving rod.

7. The control head of claim 1, wherein the shaft tube includes a bottom cover covered and coupled to the bottom of the shaft tube, and both ends of the elastic member press against internal surface of the bottom cover of the valve seat and a surface of the cap body of the moving rod.
